(19) United States
(12) Patent Application Publication
(10) Pub. No.: US 2001/0032435 A1
(43) Pub. Date: Oct. 25, 2001

(54) Methods and apparatus for providing fall-arrest protection

(76) Inventor: Barry J. Austin, Eagan, MN (US)

Correspondence Address: Robin A. Sannes, Mau & Krull, P. A., Suite E, 1250 Moore Lake Drive East, Fridley, MN, 55432, US

(21) Appl. No.: 09/785,562

(22) Filed: Feb. 16, 2001

Related U.S. Application Data
(60) Provisional application No. 60/183,537, filed on Feb. 18, 2000.

(51) Int. Cl. E04G 21/32; A62B 35/00

(52) U.S. Cl. 52/749.12; 52/704; 52/707; 52/27; 52/745.19; 52/250; 182/3; 182/39

(57) ABSTRACT

A portable fall-arrest system is designed for convenient attachment and/or removal relative to a concrete beam. The system includes stanchions which are preferably secured to respective anchorages embedded within a reinforced concrete beam. The anchorages may alternatively be used to support other types of personnel safety devices. The preferred embodiment anchorage may be described as a flared coil loop insert having a threaded neck. The loop is disposed inside the concrete beam and the neck extends to the outer surface of the concrete beam. The neck is sized and configured to receive and retain a threaded shaft associated with a safety device. The anchorage provides a convenient and reliable anchor point in a concrete beam without drilling into the beam and/or potentially weakening its structural integrity.

### FIELD OF THE INVENTION

The present invention relates to methods and apparatus for providing fall-arrest protection.

### BACKGROUND OF THE INVENTION

Various occupations place people in precarious positions at relatively dangerous heights, thereby creating a need for fall-arresting safety apparatus. Among other things, such apparatus usually include a safety line interconnected between a support structure and a person working in proximity to the support structure. A temporary horizontal lifeline is one type of fall protection system typically used in the construction of buildings.

Various lifelines and safety rails have been conventionally employed as safety devices in connection with the construction and maintenance of buildings. In conventional safety systems to which the invention relates, lifelines are directly or indirectly anchored to a fixed support structure, and connected to a safety belt or harness worn by the worker, typically via a lanyard. One of the critical concerns with such safety systems is anchoring the safety device to the building so that the safety device remains effectively anchored should it be subject to severe loading due to a fall event. Providing a suitable anchoring structure sometimes proves especially troublesome during construction of a building.

For some construction projects, it is common for pre-cast concrete decking panels or planks to be lifted and positioned on a framework to form the floors or decks of the structure. Such pre-cast panels are typically four feet wide and eight inches thick. Opposite sides of the panel are slightly tapered and are traversed by groove-like channels that function as lifting notches. The panels are typically hollow core members manufactured from reinforced concrete. The panels are grabbed at the notches by tongs or hooks for lifting of the panels into position. It has been recognized that fall protection of workers is a particular problem during the installation of pre-cast concrete deck panels because of the difficulty of providing an effective anchoring location for a lifeline. During conventional pre-cast panel construction techniques, it is highly desirable and often necessary that the workers essentially be positioned near the leading edge of the deck as the panels are moved into position so that the next panel in sequence may be properly positioned.

Typically in construction, concrete floors of buildings are reinforced with pre-tensioned steel rods to strengthen the concrete's resistance to tension, which is otherwise weak. It is potentially problematic when workers drill into the concrete floors reinforced with the pre-tensioned steel rods to install temporary horizontal lifeline systems, because there is a risk of drilling into the pre-tensioned steel rods, thus weakening the concrete floor. In other words, it would be preferable to install safety systems without exposing the beams to potential damage.

### SUMMARY OF THE INVENTION

One aspect of the present invention is to install a horizontal safety line relative to a beam. In this regard, at two or more discrete locations along the beam, respective rods are threaded into respective anchor members which are disposed, at least part, within the beam. A respective stanchion slides over each rod in such a manner that a base plate lies flush on top of the beam, and the rod protrudes upward beyond the top of the stanchion. A respective nut is threaded onto the upper end of each rod to secured a respective stanchion in place.

The safety line is secured between the stanchions to provide a horizontally extending support for purposes of limiting a person's fall.

Another aspect of the present invention is to embed one or more anchor members within a beam during the manufacturing process. Each anchor member is arranged so that a relatively larger diameter base portion is disposed inside the beam, and a relatively smaller diameter neck portion extends to the upper surface of the beam. These anchor members are suitable for receiving the rods discussed in the preceding paragraph or for receiving connectors for other types of safety systems. Additional features and/or advantages of the present invention may become apparent from the more detailed description that follows.

### BRIEF DESCRIPTION OF THE DRAWINGS

With reference to the figures of the drawing, wherein like numerals reference like parts throughout the several views,

FIG. 1 is a side view of a first horizontal safety line system constructed and installed according to the principles of the present invention;

FIG. 2 is a top view of a stanchion which is a component of the horizontal safety line system shown in FIG. 1;

FIG. 3 is a side view of the stanchion of FIG. 2;

FIG. 4 is a side view of a single point safety line system constructed and installed according to the principles of the present invention;

FIG. 5 is a sectioned side view of an anchor member which is a component of the systems shown in FIGS. 1 and 4;

FIG. 6 is a side view of a second horizontal safety line system constructed and installed according to the principles of the present invention; and

FIG. 7 is a perspective view of an anchor member which is a component of the system shown in FIG. 6.

### DETAILED DESCRIPTION OF THE PREFERRED EMBODIMENT

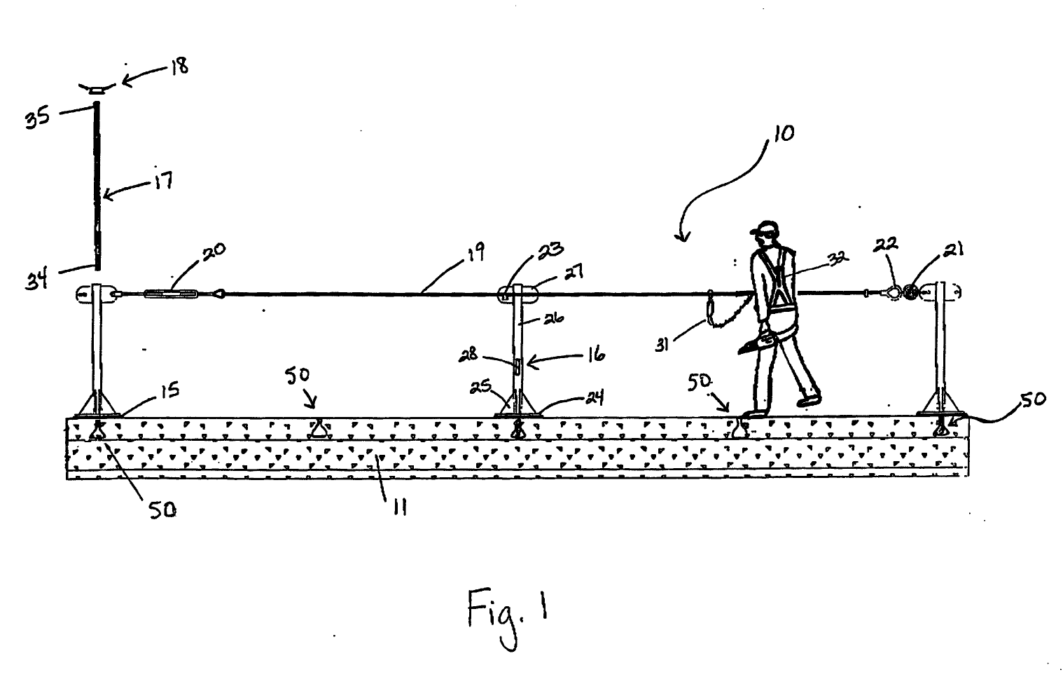

A first horizontal safety line system constructed according to the principles of the present invention is designated as 10 in FIG. 1. The system 10 may be described generally with reference to a line supporting system and an anchorage system.

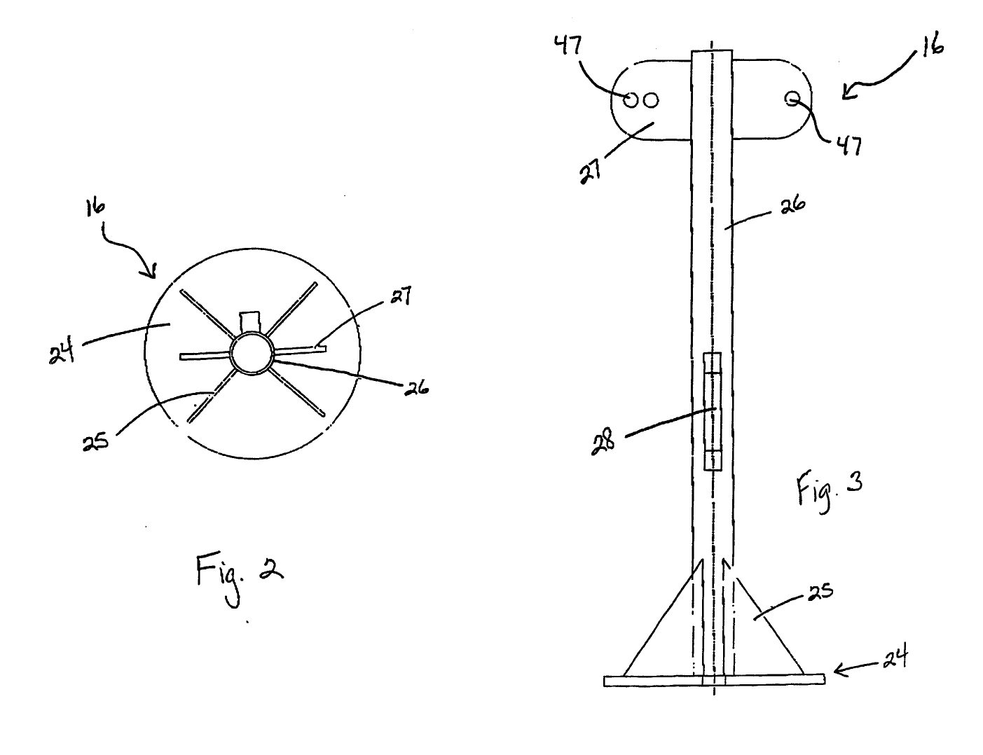

The line supporting system includes stanchions 16, one of which is shown by itself in FIGS. 2-3. Each of the stanchions has a base plate 24; a post 26 having a first end secured to the base plate 24; gusset plates 25 interconnected between the base plate 24 and the post 26; a closed loop handle 28 mounted on an intermediate portion of the post 26; and a connector plate 27 mounted on a second, opposite end of the post 26. Holes 47 in the connector plate 27 facilitate interconnections with turnbuckles, line supporting brackets, energy absorbing devices, and the like (all of which are known in the art). The handles 28 on the stanchions 16 can be used for lifting purposes or as an intermediate line guide for an edge warning line.

The anchorage system includes inserts 50 which are imbedded in the beam 11 during its manufacture. In this regard, a concrete mixture and reinforcing bars are combined to form the concrete beam 11, but a desired number of inserts 50 are placed in the concrete mixture before it solidifies. The base portions 55 are embedded in the concrete beam 11 with the neck portions 51 extending to the outer surface of concrete beam 11. The concrete mixture is allowed to solidify with the inserts 50 permanently embedded therein, thus creating convenient and reliable anchor points in the beam 11. Several anchor points 50 may be positioned at various locations in the beam 11 depending upon anticipated uses and/or applications.

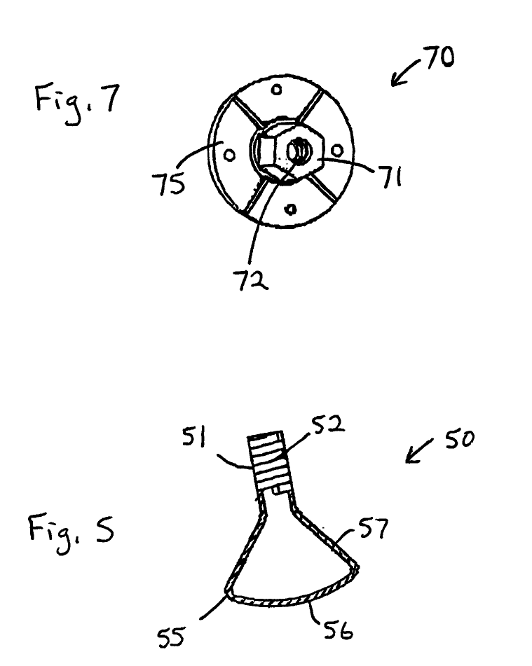

One of the inserts is shown by itself in FIG. 5. The neck portion 51 may be described as a cylindrical tube provided with internal threads 52. The base portion 55 may be described as a bulbous shell having a downwardly convex bottom wall 56 and a conical sidewall 57 which extends in convergent fashion from the bottom wall 56 to the neck portion 51. The neck portion 51 and the base portion 55 cooperate to define an uninterrupted outer surface.

The horizontal safety line system 10 is installed by placing a respective tar joint board 15 on the beam 11 and about each insert 50. A first end 34 of a respective threaded shaft 17 is inserted through each board 15 and threaded into the neck portion 51 of a respective insert 50. A respective stanchion 16 is placed over each shaft 17 so that the base plate 24 rests on the tar joint board 15, and the second end 35 of the shaft 17 protrudes above the upper end of the tubular post 26. A respective wing nut 18 is threaded onto the second end 35 of a respective shaft 17 to securely fasten a respective stanchion 16 to the beam 11. A turnbuckle 20 is secured in series between the connector plate 27 on an end stanchion 16 and one end of a cable 19. A cable bracket 23 is mounted on the intermediate stanchion 16, and an intermediate portion of the cable 19 is routed through the bracket 23. An energy absorber 21 is secured in series between the connector plate 27 on the opposite end stanchion 16 and a thimble clamp 22 connected to an opposite end of the cable 19.

Once the horizontal safety line system 10 has been installed, a worker may connect himself thereto. For example, a lanyard 31 is shown interconnected between cable 19 and a harness 32 that is worn by a worker. The depicted horizontal safety line system 10 is capable of supporting two workers at any one time. The system 10 is preferable configured so that the maximum deflection of cable 19 does not exceed 52 inches; the cable 19 is tensioned to approximately 220 pounds; the intermediate anchor point loading does not exceed 2700 pounds; and the end anchor points is capable of supporting 8000 pounds. The horizontal safety line system 10 may be repositioned relative to one or more beams 11 simply by relieving tension in the cable 19; removing the wing nuts 18; moving the stanchions 16 to alternative insert 50 locations; and reinstalling the stanchions 16 and cable 19.

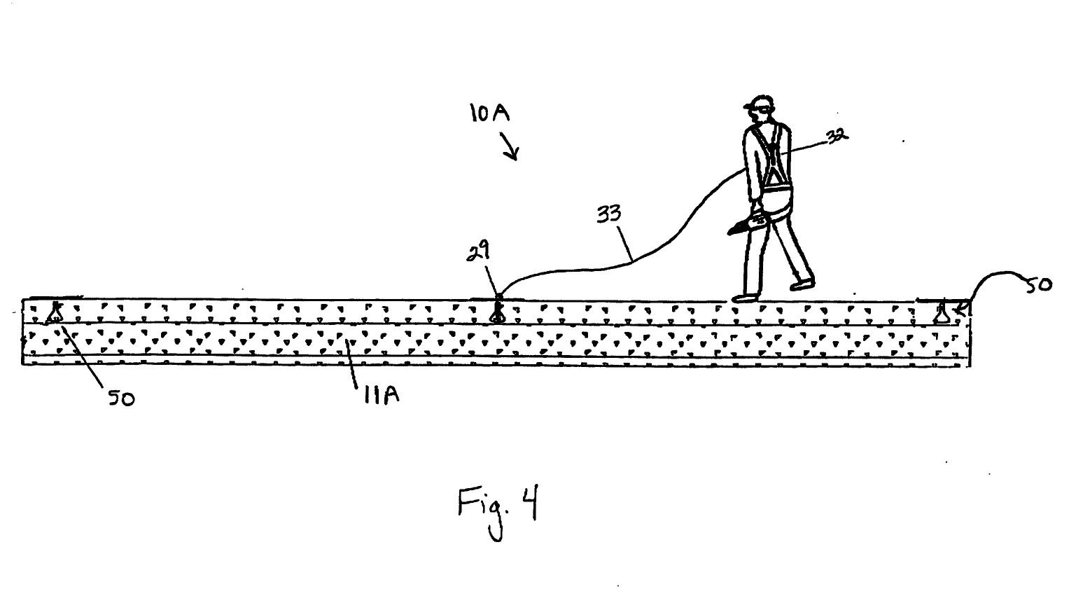

As shown in FIG. 4, an individual safety line 33 may be attached directly to the concrete anchor point 50 rather than using the whole temporary horizontal lifeline system 10. In this application, the distal end of an eyebolt 29 is threaded directly into the neck portion 51, and the lifeline 33 is secured to the closed loop portion of the eyebolt 29. With this individual system 10A, a worker may readily anchor himself to different locations on the support structure or beam 11A. Additional, unused inserts 50 are shown in the beam 11 of FIG. 1 to emphasize that there can be more inserts 50 than stanchions 16, and/or that a worker can secured an individual line to one insert 50 while installing a horizontal system relative to adjacent inserts 50.

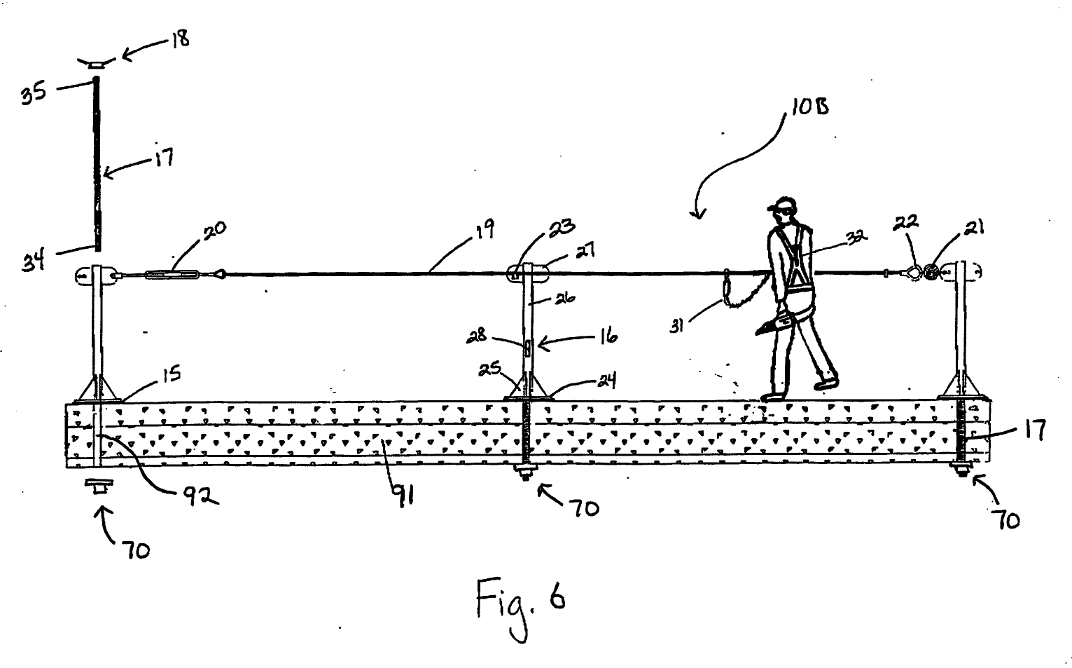

FIG. 6 shows a second horizontal safety line system 10B constructed and installed according to the principles of the present invention. As suggested by the common reference numerals, many of the components of the system 10B are identical to those of the first system 10. However, the alternative system 10B is installed relative to a beam 91 that was not manufactured with imbedded inserts 50. As a result, holes 92 were drilled through the beam 91 to receive the threaded shafts 17. The shafts 17 are inserted through respective holes 92 and secured to respective nuts 70. One of the nuts 70 is shown by itself in FIG. 7. The nut 70 may be described in terms of a neck portion 71 and a base portion 75. The neck portion 71 is a hex nut having internal threads 72, and the base portion 75 is a relatively larger diameter washer.

This disclosure sets forth particular embodiments and specific applications of the present invention and is likely to lead those skilled in the art to arrive at additional embodiments and/or applications. Accordingly, the scope of the present invention should be limited only to the extent of any allowed claims.

What is claimed is:

1. A fall-arrest system, comprising:
at least one reinforced concrete beam having an outer surface;
an insert permanently embedded in the concrete beam, the insert having an internally threaded neck extending through the concrete beam to the outer surface; and
a threaded shaft having a first end threaded into the neck, and a second end secured to a fall-arrest device.

2. The system of claim 1, wherein an internal end of the neck is integrally connected to a bulbous shell.

3. The system of claim 1, wherein the shaft is part of an eyebolt.

4. The system of claim 1, wherein the shaft extends through a stanchion for a horizontal safety line, and a nut is threaded onto an end of the shaft opposite the insert.

5. The system of claim 1, wherein the concrete beam has a length, and one said insert is provided every four feet along the length.

6. A concrete beam insert, comprising:
a base portion bounded by a bottom wall and a conical sidewall, wherein the sidewall extends in convergent fashion away from the bottom wall; and
a neck portion provided with internal threads, wherein the neck portion is connected to an end of the conical sidewall opposite the bottom wall.

7. The insert of claim 6, wherein the base portion and the neck portion cooperate to define an uninterrupted outer surface.

8. The insert of claim 7, wherein the base portion is hollow.

9. The insert of claim 6, wherein the sidewall and the neck portion define an outside angle of approximately one hundred and forty degrees therebetween.

10. The insert of claim 6, wherein the bottom wall is outwardly convex.

11. A temporary horizontal lifeline system, comprising:
a beam having a top and a bottom;
at least two stanchions, each having a post, a base plate mounted on a first end of the post and extending perpendicular relative thereto, and a line anchor mounted on an opposite, second end of the post;
for each of the stanchions, a mounting means for mounting the base plate flush against the beam; and
a safety line connected between the stanchions.

12. The system of claim 11, wherein each of the stanchions further includes a closed loop defined on an intermediate portion of the post, and the closed loop is sized and configured as a handle.

13. The system of claim 11, wherein the mounting means includes a threaded shaft, a threaded nut, and a threaded anchor, and the shaft is inserted through the post, and one end of the shaft is threaded into the anchor with at least a portion of the beam captured between the anchor and the base plate, and the nut is threaded onto an opposite end of the shaft.

14. The system of claim 13, wherein the anchor is permanently embedded in the beam.

15. The system of claim 13, wherein the anchor is disposed on a side of the beam opposite the base plate, and the shaft is inserted through a hole extending through the beam.

16. A method of installing a fall-arrest device relative to a beam, comprising the steps of:
providing an anchorage with a base portion and a neck portion;
combining a concrete mixture and reinforcing bars to form a beam having an outer surface;
before the concrete mixture has solidified, embedding the base portion in the beam in such a manner that the neck portion extends through the concrete mixture to the outer surface of the beam;
allowing the concrete mixture to solidify; and
securing the fall arrest device to the anchorage.

17. The method of claim 16, wherein the securing step involves threading a shaft through the neck portion until it encounters resistance from the base portion.

18. The method of claim 17, wherein the securing step further involves sliding a stanchion over the shaft and threading a nut onto an opposite end of the shaft, thereby squeezing the stanchion between the nut and the beam.

19. The method of claim 16, wherein the anchorage is provided with a bulbous base portion and an internally threaded neck portion.

20. The method of claim 16, wherein the anchorage is provided with an internally threaded neck portion, and a base portion having a relatively larger diameter than the neck portion.
